(19) United States
(12) Patent Application Publication
(10) Pub. No.: US 2004/0064726 A1
(43) Pub. Date: Apr. 1, 2004

(54) Vulnerability management and tracking system (VMTS)

(76) Inventor: Mario Girouard, Gatineau (CA)

Correspondence Address: FISH & RICHARDSON P.C., 1425 K STREET, N.W., 11TH FLOOR, WASHINGTON, DC, 20005-3500, US

(21) Appl. No.: 10/259,763

(22) Filed: Sep. 30, 2002

(51) Int. Cl. G06F 11/30

(52) U.S. Cl. 713/201

(57) ABSTRACT

Vulnerabilities may be managed by receiving a vulnerability message describing a profile of a computer system vulnerable to a threat, identifying one or more vulnerable systems with the profile described in the received vulnerability message, the vulnerable systems having a vulnerability that may be exploited by the threat, and generating a display that includes a list of the identified vulnerable systems.

### TECHNICAL FIELD

This description relates to computer system security, and more particularly to managing updates to system security.

### BACKGROUND

The Internet is an environment rife with hostile threats. Hackers, viruses, and worms pose constant threats to computer systems, and new threats are constantly emerging. Some organizations, such as CERT (“Computer Emergency Response Team”), inform the public of vulnerabilities and threats that have been discovered. However, there are so many alerts that it becomes difficult for an administrator to stay abreast of the risks and implications of these threats. Furthermore, even if the risk is understood, determining which systems are vulnerable and managing multiple risks complicate the response.

### SUMMARY

In one general aspect, managing vulnerabilities includes receiving a vulnerability message that describes a profile of a computer system vulnerable to a threat. One or more vulnerable systems with the profile described in the received vulnerability message, and having a vulnerability that may be exploited by the threat, then are identified. Finally, a display that includes a list of the identified vulnerable systems is generated.

Implementations may include one or more of the following features. For example, one or more corrective actions may be identified that may be performed to address the vulnerability. The corrective action may include, for example, installing a software code segment that addresses the vulnerability or filtering network traffic that conforms to a threatening profile.

Generating the display may include displaying a corrective action. Displaying the corrective action may include displaying resources required to perform the corrective action. Displaying the corrective action also may include displaying more than one corrective action for the vulnerability, with each of the more than one corrective actions relating to a different degree of required complexity. A corrective action may be displayed so as to enable an administrator to launch a work order to address the vulnerability. The status of the work order may be tracked in an automated manner. Receipt of the work order may be confirmed with a receipt message indicating that the work order has been received and viewed by a human operator.

A confirmation message may be received indicating that the vulnerable system has become a secured system for which the vulnerability has been addressed. The secured system may be probed to verify that the vulnerability no longer exists. Generating the display may include enabling an administrator to select an action from a management display that enables the administrator to launch a work order to perform a corrective action, prompt another administrator for additional information describing the impact, or reject the work order. The management display also may include an action to enable technical modifications of the work order to be made.

An administrator may be prompted to enter an importance level associated with the vulnerable system to prioritize a work order. Identifying the vulnerable systems may include analyzing a database of computer systems with one or more parameters descriptive of the computer systems. Identifying the vulnerable systems may include probing a network of one or more computer systems for vulnerabilities. Receiving a vulnerability message may include prompting an administrator to transfer information appearing in a vulnerability message into a profile database used to identify one or more computer systems. Information related to the vulnerability may be added to a library of vulnerabilities. One or more systems in a network of systems may be compared with threats described in the library of vulnerabilities.

A code segment may be retrieved that addresses the vulnerability, and an administrator may be enabled to access and/or install the code segment. A package may be created that includes the code segment and is configured to automate an installation of the code segment coordinated with one or more operations requirements.

Implementations may include a system and program capable of achieving the above features. Other features will be apparent from the following description, including the drawings, and the claims.

### DESCRIPTION OF DRAWINGS

FIG. 1 is a diagram of a communications system configured to automate the processing of a vulnerability message and a responsive action.

FIG. 2 is a diagram of components in a communications system configured to automate security alert and response operations.

FIG. 3 is a flow chart of how a communications system may process a vulnerability message that includes a profile of a computer system vulnerable to a threat.

FIG. 4 is a flow chart of how a communications system may coordinate the response to an identified vulnerability.

FIG. 5 is a graphical user interface that might be displayed to an administrator of a communications system.

Like reference symbols in the various drawings indicate like elements.

### DETAILED DESCRIPTION

Generally, vulnerabilities may be managed by receiving a vulnerability message, identifying systems with the profile described in the message, and generating a display that includes a list of the identified vulnerable systems. A corrective action may be generated in response to identifying and displaying the vulnerable systems. This may include enabling a manager to launch a work order to install a patch on a vulnerable system.

For example, a security system may transmit a message to a vulnerability management system to indicate that a certain operating system release without a certain patch is vulnerable to exploitation. The vulnerability management system may identify which systems are vulnerable. A list of vulnerable systems may be sent as a HTML form to a manager. The manager may prioritize a list of vulnerable systems. For example, some systems may be deemed as important and requiring immediate corrective action. Other systems may be deemed as less important and permitting a delayed corrective action.

The manager may select one or more corrective actions to be taken. The corrective actions may reflect the priorities. For example, work orders on critical systems may be started immediately while work orders for less important vulnerable systems may be deferred.

The manager may track the status of the work order. For example, the manager may receive information that the work order is 50% complete. Upon completion of the work order, the vulnerability manager may confirm that the vulnerability has been addressed. For example, the vulnerability manager may probe the computer system that has undergone the corrective action.

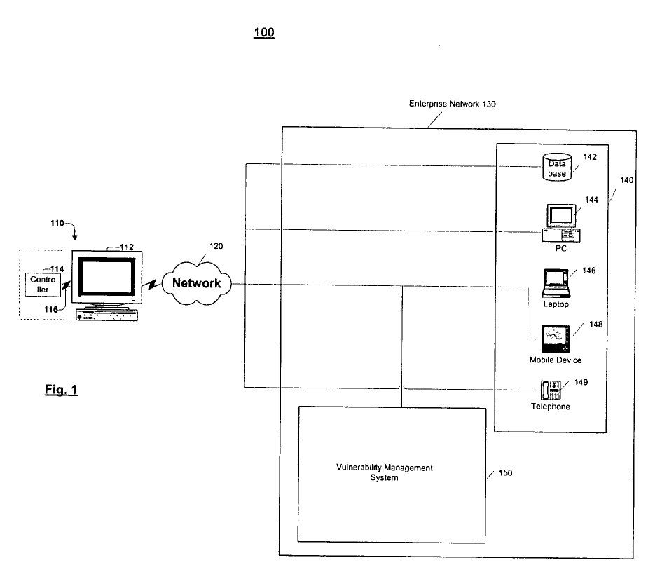

Referring to FIG. 1, a communications system 100 illustrates a security system 110 configured to coordinate vulnerabilities with an enterprise network 130. Specifically, the security system 110 may transmit a vulnerability message to the enterprise network 130. The enterprise network 130 then may coordinate the response to the vulnerability that has been identified for one or more systems in the enterprise network 130.

The security system 110 includes a computer system configured to transmit a vulnerability message that describes a profile of a computer system vulnerable to a threat. Generally, the security system 110 includes a security device 112, a security controller 114, and a controller link 116.

The security system 110 typically includes one or more security devices 112 and/or security controllers 114. For example, the security system 110 may include one or more general-purpose computers (e.g., personal computers), one or more special-purpose computers (e.g., devices specifically programmed to communicate with each other and/or the enterprise network 130), or a combination of one or more general-purpose computers and one or more special-purpose computers. The security system 110 may be arranged to operate within or in concert with one or more other systems, such as for example, one or more LANs (“Local Area Networks”) and/or one or more WANs (“Wide Area Networks”).

The security device 112 is generally capable of executing instructions under the command of a security controller 114. The security device 112 is connected to the security controller 114 by a wired or wireless data pathway 116 capable of delivering data.

The security device 112 and security controller 114 each typically includes one or more hardware components and/or software components. An example of a security device 112 is a general-purpose computer (e.g., a personal computer) capable of responding to and executing instructions in a defined manner. Other examples include a special-purpose computer, a workstation, a server, a device, a component, other equipment or some combination thereof capable of responding to and executing instructions. An example of security controller 114 is a software application loaded on the security device 112 for commanding and directing communications enabled by the security device 112. Other examples include a program, a piece of code, an instruction, a device, a computer, a computer system, or a combination thereof, for independently or collectively instructing the security device 112 to interact and operate as described herein. The security controller 114 may be embodied permanently or temporarily in any type of machine, component, equipment, storage medium, or propagated signal capable of providing instructions to the security device 112.

The network 120 includes one or more communications components configured to enable the security system 110 to exchange vulnerability information with the enterprise network 130. The network 120 may include a direct link between the security system 110 and the enterprise network 130, or it may include one or more networks or subnetworks between them (not explicitly shown). Each network or subnetwork may include, for example, a wired or wireless data pathway capable of carrying and receiving data. Examples of network 120 include the Internet, the World Wide Web, WANs (“Wide Area Networks”), LANs (“Local Area Networks”), analog or digital wired and wireless telephone networks (e.g., PSTN (“Public Switched Telephone Network”), ISDN (“Integrated Services Digital Network”), or xDSL (“any form of Digital Subscriber Loop”)), radio, television, cable, satellite, and/or other delivery mechanisms for carrying data.

The enterprise network 130 includes computer systems configured to support an enterprise or organization. The enterprise network 130 may include a corporate network, an e-commerce network, an application service provider, an online service provider, and/or another array of systems. The enterprise network system 130 includes an enterprise resource 140 and a vulnerability management system 150. The enterprise resource 140 may include one or more computer systems configured to support the enterprise network 130. Depending on the configuration of the enterprise network 130 and the mission and purpose of the organization supported by the enterprise network 130, the particular configuration of the enterprise network 130 may differ. FIG. 1 shows several examples of devices that may be included in the enterprise network 130. However, other devices that are not shown in FIG. 1 also may be included in the enterprise network 130.

Generally, the enterprise resource 140 includes one or more devices to support the enterprise network 130. Examples of the enterprise resource 140 may include a database 142, a PC (“Personal Computer”) 144, a laptop computer 146, a mobile device 148, and a telephone system 149. Examples of other enterprise resources that are not shown may include various types of networking components (e.g., routers, switches, hubs, fax machines, voice gateways, servers, and other devices). The database 142 typically includes one or more devices configured to serve as a data repository for the enterprise network 130. Typically, the database 142 may include a server or computing system configured to enable other devices to access and search the data. Other examples of the database 142 may include a mainframe computing system, and/or a workgroup system. Services running on the database 142 may include directory services, web services, application hosting services, messaging services, and/or other services.

Typically, the PC 144 may include a computing device configured to enable a user in the enterprise to access enterprise resources in the enterprise network 130.

The laptop 146 typically includes a computer configured for mobile use. Generally, aspects of the laptop 146 may resemble aspects of the PC 144 described previously. The laptop 146 may include one or more specialized devices configured to enable the laptop to serve more effectively in mobile environments. For example, the laptop 146 may include a wireless modem that enables the laptop 146 to access enterprise resources using wireless links.

The mobile device 148 may include a personal digital assistant (PDA), a wireless phone, or a tablet computer configured to enable a user in the enterprise network to access enterprise resources in the enterprise network 130. The mobile device 148 may include one or more devices configured to support the mobile environment. For example, a tablet computer may include a pen based input system configured to enable the user to input data. The mobile device 148 may have vulnerabilities associated with the mobile environment and operation.

The telephone 149 typically includes a system configured to enable a user to access a PSTN (“Public Telephone Network”). Aspects of the telephone 149 may be configured to interface with aspects of other devices in the enterprise network 130. For example, the telephone 149 may be configured to interface with a directory server (e.g., database 142). The telephone 149 may use the directory server to place outbound calls and coordinate billing information.

The vulnerability management system 150 includes one or more computer systems configured to receive a vulnerability message, identify one or more vulnerable systems, and generate a display that includes a list of vulnerable systems. Generally, the vulnerability management system 150 is configured to manage threats to an enterprise resource and coordinate the response. For example, the vulnerability system 150 may receive a message and identify which computer systems are vulnerable. The vulnerability system 150 then may coordinate the response so that the vulnerability may be addressed in a corrective action.

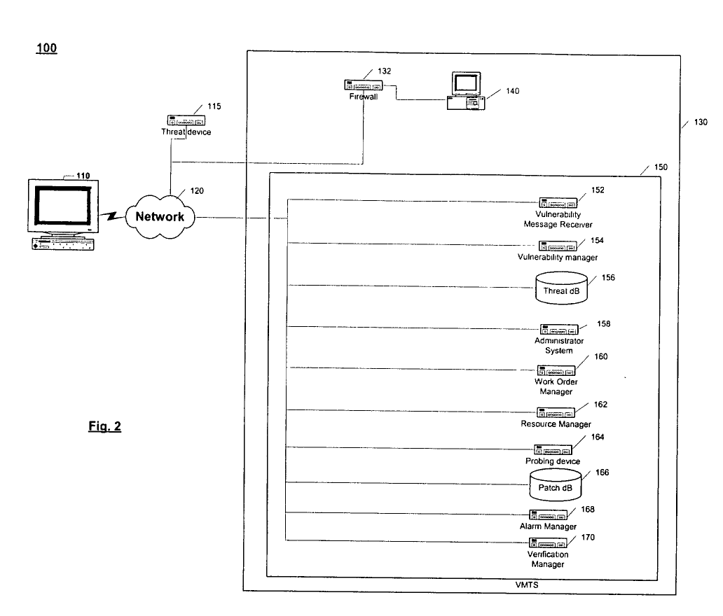

Referring to FIG. 2, a communication system 100 illustrates how a vulnerability management system may be configured to process vulnerability messages that are received from a security system 110. Generally, aspects of the communication system 100 shown in FIG. 2 relate to aspects of the systems described previously. For example, the security system 110 in FIG. 2 relates to the security system 110 in FIG. 1. Similarly, the enterprise network 130 relates to the enterprise network 130 described in FIG. 1. Although aspects of FIG. 2 resemble aspects of FIG. 1, FIG. 2 illustrates how the vulnerability management system 150 may be configured to support vulnerability message processing.

Generally, the security system 110 is configured to generate one or more vulnerability messages that describe a profile of a computer system vulnerable to a threat. The security system 110 is configured to then transmit the vulnerability message to the vulnerability management system 150. The network 120 is configured to enable the vulnerability message to be transmitted to the vulnerability management system 150, in particular, to the vulnerability message receiver 152.

The threat device 115 represents a device that is capable of exploiting the vulnerability identified in the vulnerability message. The threat device 115 is shown as interfacing with the network 120 to access the enterprise network 130. However, the threat device 115 also may include devices internal to the enterprise network 130. The enterprise network 130 includes computer systems configured to support the mission of the organization. The enterprise network 130 may include a firewall 132, an enterprise resource 140, and a vulnerability management system 150. Generally, the firewall 132 includes a networking device configured to selectively filter and forward traffic that may access the enterprise resource 140. The firewall 132 may include a server system running firewall software, a router running an access control list, and/or a proxy. The enterprise resource 140 may include computer systems configured to support the enterprise in the enterprise network 130. Examples of the enterprise resource may include a web server, a messaging server, a financial processing system, and/or another automated device.

The vulnerability management system 150 may include a device, a component, or a system configured to process a vulnerability message, identify one or more vulnerable systems, and generate an action responsive to the vulnerability message which was received. Although the devices in the vulnerability management system 150 in FIG. 2 are shown as a collection of computer systems and devices, other examples of these devices in the vulnerability management system may include code segments, and/or specialized hardware devices that work in conjunction with one another. For example, the systems described in vulnerability management system 150 may include several code segments running on a vulnerability management server. In one instance, the vulnerability message receiver 152 may include a first code segment while the vulnerability manager 154 includes a second code segment.

In the example shown in FIG. 2, the vulnerability management system 150 includes the vulnerability message receiver 152, the vulnerability manager 154, a threat database 156, an administrator system 158, a work order manager 160, a resource manager 162, a probing device 164, a patch database 166, an alarm manager 168, and a verification manager 170. The components and devices described in the vulnerability management system 150 illustrate one or more functionalities that may be present. Actual implementations may include the subset of these devices and components and/or also may be combined in a device or component that integrates several of the functions. For example, the vulnerability message receiver 152 and the vulnerability manager 154 may reside in the same program that coordinates responses to vulnerability messages that are received.

In general, each of the devices in vulnerability management system may be independently or collectively implemented by a general-purpose computer capable of responding to and executing instructions in a defined manner. Examples of the devices may include a personal computer, a special purpose computer, a workstation, a server, a device, a component, or other equipment or devices capable of responding to and executing instructions. The devices may be arranged to receive instructions from one or more of a software application, a program, a piece of code, a device, a computer, a computer system or a combination thereof, which independently or collectively direct operations, as described herein. The instructions may be embodied permanently or temporarily in any type of machine, component, storage medium, or propagated signal that is capable of being delivered to hosts.

The vulnerability message receiver 152 includes a device, component, or code segment configured to receive a vulnerability message from the security system 110 and process the vulnerability message. In one example, the vulnerability message includes an electronic mail message that is sent to systems participating in an electronic mail alert system. In another example, the vulnerability message receiver 152 maintains an active communications link with a security system 110 to receive updates. For example, an information technology provider that supports multiple organizations with information technology services may centrally manage the vulnerabilities for clients' computer systems. Thus, the central security system 110 may send the messages to vulnerability message receivers 152 that are distributed at client sites.

The vulnerability manager 154 includes a device, component, or code segment configured to manage vulnerabilities that are received by the vulnerability message receiver 152 and translate the vulnerabilities into profiles that may be compared with computer systems in enterprise network 130. This may include extracting a profile from a vulnerability message, adding the update to a library, and identifying the vulnerable systems whose profile corresponds to the profile that was received by the vulnerability message receiver 152. The vulnerability manager 154 also may determine an importance level and generate a display for management stations so that responses to the vulnerabilities may be formed. The vulnerability manager 154 may coordinate corrective action and work orders and detect additional vulnerabilities. Additionally, the vulnerability manager 154 may maintain a library of vulnerabilities (e.g., the threat database) and periodically update vulnerabilities within the enterprise network 130.

The threat database 156 includes a compilation of one or more vulnerabilities that have been received. Generally, these vulnerabilities describe a profile that may be exploited by a threat device 115. For example, the threat database 156 may include a list of operating system releases and applications associated with vulnerabilities that may be exploited. For example, one profile may indicate that a certain operating system without a certain patch may be vulnerable to a particular malicious attack. These malicious attacks may include denial of service attacks, as well as security vulnerabilities that allow unauthorized access to the computer system. For example, an unauthorized party may acquire remote administrative permissions (e.g., root access).

The administrator system 158 includes a device, component, or code segment configured to enable an enterprise network manager to receive a display of the vulnerabilities and launch corrective actions responsive to the vulnerabilities that have been identified. For example, the administrator system 158 may include an enterprise network manager's personal computer with a security management application that generates displays of the vulnerabilities. This may include a web browser or other application configured to access a server for data.

The work order manager 160 includes a component, device, or code segment configured to coordinate the corrective actions that are launched in response to identifying a vulnerability. For example, the administrator system 158 may present a manager with a list of three vulnerabilities that have been identified that may merit corrective action. The manager may be presented with a list of corrective actions. The corrective actions may include a description of the impact of performing a corrective action along with a cost to perform the corrective action.

If the manager selects one of the corrective actions, a work order may be launched. The work order tasks service personnel supporting the enterprise network 130 to address the vulnerability. The work order manager 160 may initially notify the service personnel with a message indicating what is required. The work order manager 160 may confirm that the service personnel have actually seen and are aware of the work order. The work order manager 160 then may track the completion on the work order being performed. For example, the work order manager 160 may periodically poll the service personnel to determine the state of the work order. In another example, the work order manager 160 may poll the state of the vulnerable systems to determine the extent to which the vulnerability has been addressed.

In yet another example, the work order manager 160 may use a combination of techniques to ascertain the state of the work order. For example, if a particular software upgrade has not occurred and computer systems do not detect that the work order has been accomplished, the work order manager 160 may poll the personnel to determine the status with a greater degree of precision.

The resource manager 162 includes a device, component, or code segment configured to coordinate the resources required to implement the work order that has been launched by the administrator system 158. The resource manager 162 may coordinate the financial resources required. For example, an administrator system 158 may generate a display showing that 10 hours of contracting resources are required to address a particular vulnerability. This 10 hours of contracting resources may have an associated cost. The resource manager 162 may transfer financial resources to the responsive organization so that the work order may be undertaken. In another example, the resource manager 162 may purchase and/or coordinate shipment of required parts and software to implement the responsive work order. For example, if a particular software program is to be purchased as part of the work order, the resource manager 162 may transfer the funds to purchase the required software, and/or retrieve the software required.

The probing device 164 includes a component, device, or code segment configured to determine the presence of one or more vulnerabilities. For example, the probing device 164 may scan an enterprise network 130 to determine the existence of vulnerabilities. For example, although the security system 110 may generate a particular vulnerability message and the vulnerability manager 154 may identify one or more vulnerable systems using a configuration database, the probing device 164 may determine that the vulnerability manager 154 used information that was out of date and that the vulnerability does not in fact exist. In another example, the probing device 164 may discover a vulnerability not previously identified.

The patch database 166 includes a database configured to store one or more software patches used to address the vulnerabilities. For example, an organization may maintain patches so that the patches are available in the patch database 166 during an outage.

The alarm manager 168 includes a device, component, or code segment configured to generate notifications and/or alarms for vulnerabilities. As a vulnerability message is received on the vulnerability message receiver 152, the alarm manager 168 may generate a responsive message. In one example, the vulnerability manager 154 identifies one or more systems which may be vulnerable. The alarm manager 168 then may present the list of vulnerable systems and poll a network manager for their priority. This priority then may be processed so that a manager may be polled for a corrective action. In one example, the alarm manager 168 generates a graphical user interface (e.g., pop-up display) asking the administrator for acknowledgement. In another example, the alarm manager 168 generates a message and asks one or more recipients of the message to respond to the message to acknowledge its receipt of the vulnerability message. The alarm manager 168 may generate one or more options within the notification so that the network manager may select one or more responses. For example, the manager may elect to poll engineers for additional information to better ascertain the scope and impact of the suggested corrective action. In another example of vulnerabilities that have a greater degree of impact, the network manager may respond to the message before routing the message to a more senior manager. Finally, the network manager may respond by determining that no corrective action needs to be taken at this time.

The verification manager 170 includes one or more computer systems configured to verify that the identified vulnerabilities have been addressed, so that the vulnerability no longer may be exploited. In one example, the verification manager 170 launches a process to determine that the work order has been performed so that the vulnerability no longer exists. In another example, the verification manager may launch a simulated attack. For example, if a denial of service attack has been identified in a vulnerability message, and the vulnerability manager 154 has coordinated implementation of the responsive patch, the verification manager 170 may launch the denial of service attack which has been identified to verify that the required patch has been installed.

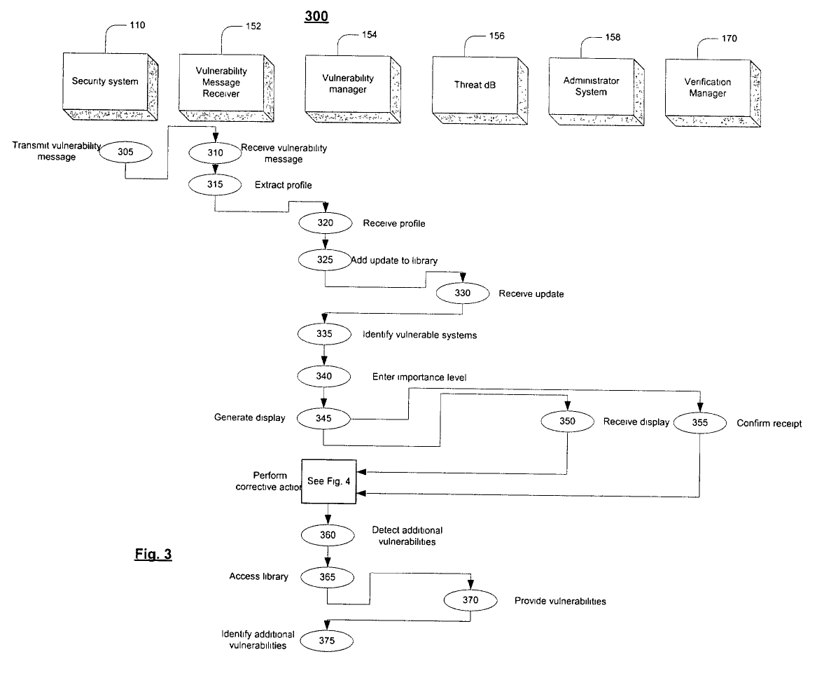

FIG. 3 illustrates a flow chart 300 showing how a vulnerability message may be processed by a vulnerability management system to address a vulnerability described in the vulnerability message. Generally, the systems described in flow chart 300 have been described previously. However, FIG. 3 illustrates how the systems described previously may interface with one another to respond to a received vulnerability message. Generally, a vulnerability management system receives a vulnerability message describing a profile of a computer system vulnerable to a threat, identifies one or more vulnerable systems with the profile described in the received vulnerability message, and generates a display that includes a list of one or more of the identified vulnerable systems. Although FIG. 3 illustrates a flow chart that has several serial events and several events in parallel, implementations are not limited to the order and/or serial/parallel combination of the events shown. For example, although entering the importance level and generating the display (steps 340 and 345) are shown as occurring sequentially, the events may be performed in reverse order. Similarly, although receiving the display and confirming receipt are shown as occurring in parallel with respect to steps 350 and 355, the events described may be performed in a serial manner rather than a parallel manner.

Initially, the security system 110 transmits a vulnerability message (step 305). Transmitting a vulnerability message may include generating an electronic mail message describing a vulnerable profile. For example, a vulnerability message may indicate an operating system, a particular release of the operating system, and a particular configuration of the operating system that may be exploited through a sequence of attacks. Other examples of the vulnerability message may include messages other than electronic mail messages. For example, the security system 110 may transmit packets from a network device to another network device configured to recognize and respond to the received packets. The packets may encode vulnerability parameters.

The vulnerability message receiver 152 receives the vulnerability message (step 310) and extracts the profile for vulnerable systems from the vulnerability message (step 315). Generally, the profile that is extracted includes a profile of a computer system that is vulnerable to a threat. The extracted profile then is sent to the vulnerability manager 154, which receives the profile (step 320).

The vulnerability manager 154 adds the update to the library (step 325). Typically, adding the update to the library may include adding one or more parameters in the profile to the database. For example, the database may organize vulnerabilities by operating systems, applications, or other parameters describing the vulnerability. The threat database 156 receives the update (step 330). The vulnerability manager 154 then may identify one or more vulnerable systems (step 335). Identifying the vulnerable systems includes identifying one or more computer systems with the profile described in the received vulnerability message. That is, the vulnerable systems are identified by having a vulnerability that may be exploited by the threat. In one example, identifying the vulnerable systems may include comparing the profile for the vulnerability with a configuration database. In this instance, the vulnerability manager 154 does not actually know that the identified systems are vulnerable to the identified threat. Rather, the vulnerability manager 154 is relying on the configuration management database. In another example, the vulnerability manager 154 may poll the identified systems to determine that they are in fact vulnerable.

The vulnerability manager 154 may enter the importance level (step 340). Generally, the importance level indicates the impact to an organization should the event occur on the identified system. In one example, entering the importance level may include prompting a manager for the importance level. A manager may be presented with a window asking the user to specify the importance of the identified system. In another example, the vulnerability manager 154 analyzes the operation and configuration of the identified system and creates an importance level for the identified system.

The vulnerability manager 154 may initially estimate an importance level and then poll the manager for the importance level of the perceived important systems. Afterwards, or in combination with identifying the vulnerable systems and entering the importance level, the vulnerability manager 154 may generate a display that includes a list of vulnerable systems (step 345). Generally, generating the display includes notifying the manager of the list of the identified vulnerable systems. In one example, generating the display may include transmitting an electronic mail message to a network manager. The electronic mail message may be sent with a confirm receipt instruction that enables the vulnerability manager 154 to confirm that the manager has actually received the message. In another example, generating the display may include generating a pop-up window describing the list of vulnerable systems. A manager's PC may include a daemon configured to generate a window displayed on the desktop when a vulnerability message is received. The message may include an HTML (“Hypertext Markup Language”) form that enables the manager to select one or more options in the form. For example, the form may include fields to enter the importance level and create a work order. The administrator system 158 receives the display (step 350). Receiving the display may include generating perceivable output for a manager to receive the list of the identified vulnerable systems.

The verification manager 170 confirms receipt of the generated display (step 355). Confirming the receipt confirms that an operator or manager is aware of the vulnerability message and systems that are identified by the vulnerability message. In one example, the verification manager 170 may include a code segment configured to confirm receipt by asking a user to click a verification button in the graphical user interface. In another example, the verification manager 170 may include a code segment associated with an electronic mail message that confirms that a user received the vulnerability message. Confirming receipt may include one or more sequences of operations designed to verify that the user actually perceives the display and notification. For example, a user may be prompted with an “are you sure” message to acknowledge the notification message.

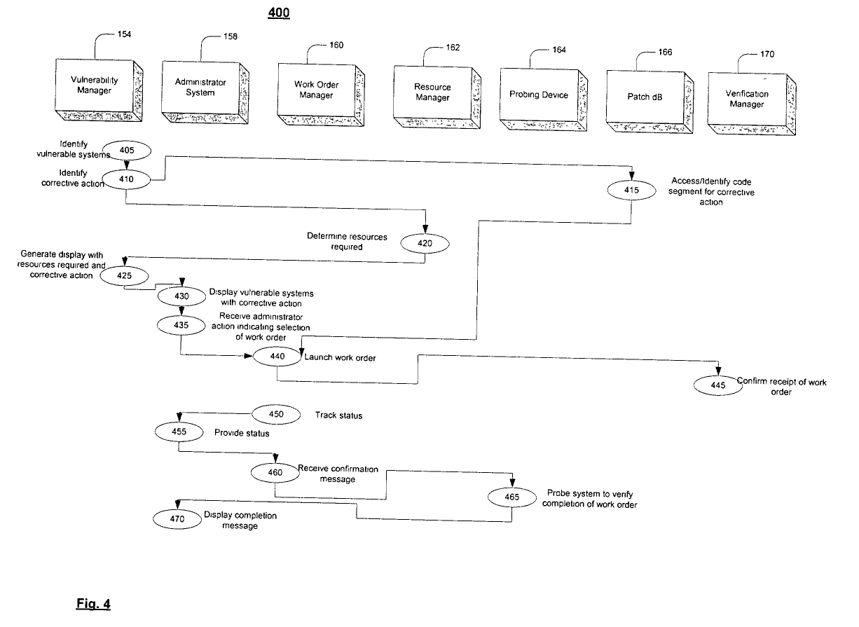

After the manager perceives the generated display, the generated display may be coupled to an action item code segment to initiate and perform a corrective action as discussed below with respect to FIG. 4. Generally, performing a corrective action includes taking responsive action so that the vulnerability may no longer be exploited. For example, a firewall may filter a particular traffic profile to prevent the vulnerability from being exploited. In another example, a patch and/or operating system upgrade may be installed to prevent the vulnerability from being exploited.

With the vulnerabilities corrected, the vulnerability manager 154 may detect additional vulnerabilities (step 360). In one example, detecting additional vulnerabilities may include analyzing lower priority vulnerabilities that were previously identified and considering whether to elevate their importance as previously more important vulnerabilities and systems have been addressed. In another example, the vulnerability manager 154 may relate a threat database 156 to a configuration database of computer systems. This may generate a list of vulnerable systems. Similarly, the vulnerability manager 154 may poll computer systems that have undergone corrective action to determine if the configuration changes have introduced any new vulnerabilities. For example, a new server may have been installed that was not previously considered when the vulnerable systems were identified. The new server may be vulnerable to a vulnerability that has been previously addressed. In another example, the vulnerability manager 154 may probe the enterprise network 130 to detect additional vulnerabilities. To detect these additional vulnerabilities, the library of vulnerabilities in the threat database 156 may be accessed (step 365). The threat database 156 may provide these vulnerabilities (step 370). With vulnerabilities provided, the vulnerability manager 154 may identify additional vulnerable systems (step 375).

Referring to FIG. 4, a flow chart 400 illustrates how an enterprise network 130 and a vulnerability management system 150 may perform a corrective action. Initially, the vulnerability manager 154 identifies one or more vulnerable systems (step 405). With the identified vulnerable systems, the vulnerability manager 154 may identify a corrective action (step 410). With the corrective action identified, the vulnerability manager 154 may interface with the patch database 166 to access and identify code segments for the corrective action (step 415). For example, a patch that addresses the vulnerability may be identified and downloaded. In another example, a change to an access control list running on a router or firewall may be identified. Accessing and identifying the code segments for the corrective action may include downloading the code segment from a third party so that the code segment is accessible to personnel responsible for the work order. For example, the code segment may be downloaded from an emergency response center and placed in a directory used by support personnel along with documentation describing the corrective action to be taken.

As corrective action is identified, the resource manager 162 may determine the resources that are required (step 420). Generally, determining the resources that are required may include determining the hours and/or the availability of personnel required to perform the corrective action. There may be more than one solution that addresses the vulnerability. For example, to address a vulnerability in a server, one solution may include installing a software patch. This software patch may involve a substantial outage and involve a high level of complexity, which may require a large number of contractor hours for implementation. Alternatively, a firewall policy or security rule may be loaded to a firewall that prevents traffic conforming to a threatening profile from reaching the server. This may prevent the vulnerability from being exploited and require fewer resources. With the required resources determined, the vulnerability manager 154 may generate the display with the resources required to perform the corrective action (step 425). The administrator system 158 may display the vulnerable systems with the corrective action (step 430). The administrator system 158 then may receive an administrator action indicating a selection of a particular work order (step 435). For example, a manager may install a new security policy on a firewall rather than perform a software upgrade on a server. In another example, the administrator may defer or reject performing any corrective action.

However, when some corrective action is selected, the administrator system 158 generates a message to launch a work order using the work order manager 160 (step 440). Generally, launching the work order includes tasking support personnel to perform a specified action to address the vulnerability. Launching the work order also may include verifying and confirming that the support personnel have received the work order (e.g., using the verification manager 170) (step 445). The work order manager 160 may track the status of the work order as it progresses (steps 450). Tracking the status may include determining the estimated completion time.

The administrator system 158 then may be configured to provide the status to a manager (step 455). With the work order status provided, the work order manager 160 may receive a confirmation message indicating that the manager has in fact viewed the status of the work order (step 460). With the confirmation of the work order complete, the probing device 164 may probe the computer system that was the subject of the work order to verify the completion of the work order (step 465). The administrator system 158 then may display a completion message (step 470).

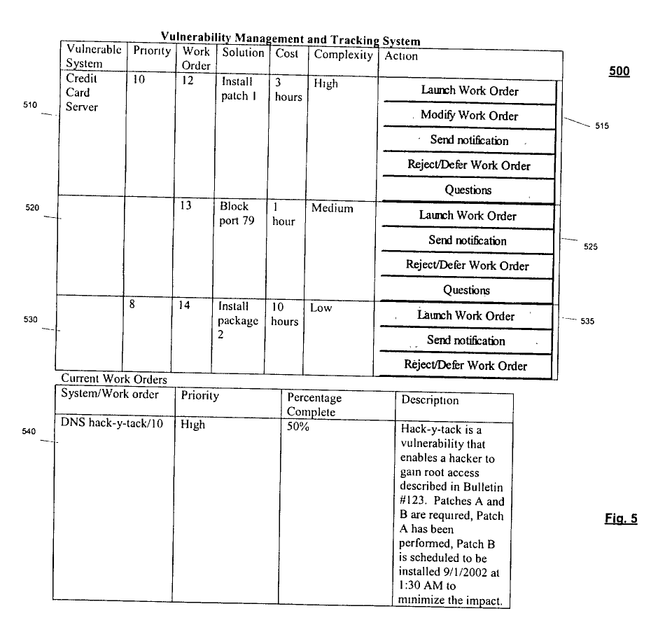

Referring to FIG. 5, a GUI (“Graphical User Interface”) 500 illustrates an exemplary display that shows a list of vulnerable systems that have been identified. Generally, the GUI 500 shows a prioritized list of vulnerable systems with information describing the vulnerability, a proposed solution to fix the vulnerability, and tools to enable generation of a work order to perform a corrective action. GUI 500 includes an exemplary vulnerability for a credit card server with three proposed solutions 510, 520, and 530. Additionally, a current work order 540 shows an exemplary vulnerability being addressed.

For the exemplary vulnerability on the credit card server with proposed solutions 510, 520 and 530, each proposed solution has a number of associated fields. The fields that are shown in the GUI 500 system include a priority, a work order number, a solution, a cost, a complexity and an action (e.g., action item window 515 for work order 510, and action item 525 for work order 520). For work orders 510/520, there are common elements describing the vulnerable system, which in this case identifies the credit card server and the priority of the vulnerability. This indicates a high priority, and is the same for work orders 510/520. However, work order 510 includes a solution to install patch one whereas work order 520 proposes to block port 79.

There is a cost column associated with each work order which indicates the cost. For work order 510 the cost is 3 hours, and the cost of work order 520 is 1 hour. This example shows the cost occurring in hours. However, in other cases, the cost may be expressed in dollars or other units. Each of the work orders has a complexity associated with the work order. Work order 510 is considered highly complex and work order 520 is considered to be of medium complexity.

Each of the work orders includes a collection of action item buttons that appear in an action item window (e.g., action item window 515 and action item window 525). For example, in the case of work order 510 (installing a patch), there are five buttons shown in action item window 515. The action item buttons in action item window 515 enable a user to launch a work order, modify a work order, send notification, reject/defer a work order, and/or ask questions.

Each of these buttons may generate additional displays and may prompt an administrator for additional information. For example, if the question button is selected, a manager may direct a question to the technical staff. Similarly, if the work order is deferred, a higher-level manager may be prompted for the decision.

For work order 520, a different set of action item window buttons is displayed in action item window 525. Action item window 525 enables a user to launch a work order, send notification, reject or defer the work order, or ask questions. Note that work order 520 does not enable the user to modify the work order. There may be one or more reasons for this difference. In one example, the work order may be generated so that the work order does not require modification. In another example, blocking port 79 does not involve additional modifications.

Modifying a work order may include scheduling a time to perform the work order so that operations of the enterprise network 130 are not interrupted. For the DNS server vulnerability work order 530, the parameters reflect a priority of 8, which is below the priority of the credit card server. This may be because the credit card server may interrupt revenue operations and the particular DNS server vulnerability may enable a hostile user to exploit the DNS server but will not cause financial losses. Additionally, the work order 530 includes a work order number to enable an administrator to distinguish between the different work orders. The work order 530 has a solution to install package two, estimated to cost 10 hours worth of work. In this example, the solution is considered of low complexity. Action items window 535 enables the administrator to launch a work order, send notification, or reject or defer the work order.

Additionally, appearing below the list of vulnerabilities is a list of work orders. Work order 540 is identified as “DNS hack-y-tack”, with a work order number of 10, and an associated high priority. Work order 540 is 50% complete. Additionally, there is a description of the system and the work order that indicates the hack-y-tack vulnerability enables a hacker to gain access described in a bulletin #123. The description shows that patches A and B are required, the patch A has been performed, and that patch B is scheduled to be installed on a certain date and at a certain time to minimize the impact.

Other displays may be used. For example, one display may be used to prompt the user to enter the priority/importance of one or more computer systems. Another display may be used to confirm that the user has received the vulnerability message, the vulnerability notification, and the work order notification and verifications.

Other implementations are within the scope of the following claims. For example, the vulnerability management system 150 may be distributed across one or more systems located throughout a network and information technology provider (e.g., a contractor supporting the organization). In another example, one or more proxies may be used to coordinate responses and work orders for multiple systems. For example, an administrator system 158 may use a proxy to coordinate multiple probing devices 164.

What is claimed is:

1. A method of managing vulnerabilities, the method comprising:
receiving a vulnerability message describing a profile of a computer system vulnerable to a threat;
identifying one or more vulnerable systems with the profile described in the received vulnerability message, the vulnerable systems having a vulnerability that may be exploited by the threat; and
generating a display that includes a list of the identified vulnerable systems.

2. The method of claim 1 further comprising identifying one or more corrective actions that may be performed to address the vulnerability.

3. The method of claim 2 wherein the corrective action includes installing a software code segment that addresses the vulnerability.

4. The method of claim 1 wherein the corrective action includes filtering network traffic conforming to a threatening profile.

5. The method of claim 1 wherein generating the display includes displaying a corrective action

6. The method of claim 5 wherein displaying the corrective action includes displaying resources required to perform the corrective action.

7. The method of claim 5 wherein displaying the corrective action includes displaying more than one corrective action for the vulnerability, with each of the more than one corrective actions relating to a different degree of required complexity.

8. The method of claim 5 wherein displaying the corrective action includes enabling an administrator to launch a work order to address the vulnerability.

9. The method of claim 8 further comprising enabling a status of the work order to be tracked in an automated manner.

10. The method of claim 8 further comprising confirming receipt of the work order with a receipt message indicating the work order has been received and viewed by a human operator.

11. The method of claim 1 further comprising receiving a confirmation message indicating that the vulnerable system has become a secured system, wherein the secured system comprises a computer system for which the vulnerability has been addressed.

12. The method of claim 11 further comprising probing the secured system to verify that the vulnerability no longer exists.

13. The method of claim 1 wherein generating the display includes enabling an administrator to select an action from a management display that enables the administrator to:
launch a work order to perform a corrective action;
prompt another administrator for additional information describing the impact; and
reject the work order.

14. The method of claim 13 wherein the management display also includes an action to enable technical modifications of the work order to be made.

15. The method of claim 1 wherein an administrator is prompted to enter an importance level associated with the vulnerable system to prioritize a work order.

16. The method of claim 1 wherein identifying the vulnerable systems includes analyzing a database of computer systems with one or more parameters descriptive of the computer systems.

17. The method of claim 1 wherein identifying the vulnerable system includes probing a network of one or more computer systems for vulnerabilities.

18. The method of claim 1 wherein receiving a vulnerability message includes prompting an administrator to transfer information appearing in vulnerability message into a profile database used to identify one or more computer systems.

19. The method of claim 1 further comprising adding information related to the vulnerability to a library of vulnerabilities.

20. The method of claim 19 further comprising determining whether one or more systems in a network of systems are vulnerable to threats described in the library of vulnerabilities.

21. The method of claim 1 further comprising retrieving a code segment that addresses the vulnerability and enabling an administrator to access the code segment.

22. The method of claim 21 further comprising enabling the administrator to install the code segment.

23. The method of claim 21 further comprising creating a package that includes the code segment, the package being configured to automate an installation of the code segment coordinated with one or more operations requirements.

24. A system configured to managing vulnerabilities, the system comprising:
a communications interface structured and arranged to receive a vulnerability message describing a profile of a computer system vulnerable to a threat;
a first processor structured and arranged to identify one or more vulnerable systems with the profile described in the received vulnerability message, the vulnerable systems having a vulnerability that may be exploited by the threat; and
a second processor structured and arranged to generate a display that includes a list of the identified vulnerable systems.

25. The system of claim 24 further comprising a third processor structured and arranged to identify one or more corrective actions that may be performed to address the vulnerability.

26. The system of claim 25 wherein the corrective action includes installing a software code segment that addresses the vulnerability.

27. The system of claim 26 wherein the corrective action includes filtering network traffic conforming to a threatening profile.

28. The system of claim 25 wherein the second processor is structured and arranged to display a corrective action

29. The system of claim 25 wherein the second processor is structured and arranged to display resources required to perform the corrective action.

30. The system of claim 28 wherein the second processor is structured and arranged to display more than one corrective action for the vulnerability, with each of the more than one corrective actions relating to a different degree of required complexity.

31. The system of claim 28 wherein the second processor is structured and arranged to enable an administrator to launch a work order to address the vulnerability.

32. The system of claim 31 further comprising a third processor structured and arranged to enable a status of the work order to be tracked in an automated manner.

33. The system of claim 31 further comprising a fourth processor structured and arranged to confirm receipt of the work order with a receipt message indicating the work order has been received and viewed by a human operator.

34. The system of claim 24 further comprising a fifth processor structured and arranged to receive a confirmation message indicating that the vulnerable system has become a secured system, wherein the secured system comprises a computer system for which the vulnerability has been addressed.

35. The system of claim 34 further comprising a sixth processor structured and arranged to probe the secured system to verify that the vulnerability no longer exists.

36. The system of claim 24 wherein the second processor is structured and arranged to enable an administrator to select an action from a management display that enables the administrator to:
launch a work order to perform a corrective action;
prompt another administrator for additional information describing the impact; and
reject the work order.

37. The system of claim 26 wherein the management display is structured and arranged to enable technical modifications of the work order to be made.

38. The system of claim 24 wherein the second processor is structured and arranged to prompt an administrator to enter an importance level associated with the vulnerable system to prioritize a work order.

39. The system of claim 24 wherein the first processor is structured and arranged to analyze a database of computer systems with one or more parameters descriptive of the computer systems.

40. The system of claim 24 wherein the first processor is structured and arranged to probe a network of one or more computer systems for vulnerabilities.

41. The system of claim 24 wherein the first communications interface is structured and arranged to prompt an administrator to transfer information appearing in vulnerability message into a profile database used to identify one or more computer systems.

42. The system of claim 24 further comprising a second communications interface structured and arranged to add information related to the vulnerability to a library of vulnerabilities.

43. The system of claim 42 further comprising a seventh processor structured and arranged to determine whether one or more systems in a network of systems are vulnerable to threats described in the library of vulnerabilities.

44. The system of claim 24 further comprising a third communications interface structured and arranged to retrieve a code segment that addresses the vulnerability and enabling an administrator to access the code segment.

45. The system of claim 44 further comprising an eighth processor structured and arranged to enable the administrator to install the code segment.

46. The system of claim 44 further comprising a ninth processor structured and arranged to create a package that includes the code segment, the package being configured to automate an installation of the code segment coordinated with one or more operations requirements.

47. A system for managing vulnerabilities, the method comprising:
means for receiving a vulnerability message describing a profile of a computer system vulnerable to a threat;
means for identifying one or more vulnerable systems with the profile described in the received vulnerability message, the vulnerable systems having a vulnerability that may be exploited by the threat; and
means for generating a display that includes a list of the identified vulnerable systems.

48. A computer program configured to managing vulnerabilities, the system comprising:
a first code segment structured and arranged to receive a vulnerability message describing a profile of a computer system vulnerable to a threat;
a second code segment structured and arranged to identify one or more vulnerable systems with the profile described in the received vulnerability message, the vulnerable systems having a vulnerability that may be exploited by the threat; and
a third code segment structured and arranged to generate a display that includes a list of the identified vulnerable systems.
